(19) United States
(12) Patent Application Publication
(10) Pub. No.: US 2015/0269669 A1
(43) Pub. Date: Sep. 24, 2015

(54) LOAN RISK ASSESSMENT USING CLUSTER-BASED CLASSIFICATION FOR DIAGNOSTICS

(71) Applicant: Xerox Corporation, Norwalk, CT (US)

(72) Inventors: Alvaro E. Gil, Rochester, NY (US); Edgar A. Bernal, Webster, NY (US); Nathan Gnanasambandam, Victor, NY (US)

(73) Assignee: Xerox Corporation, Norwalk, CT (US)

(21) Appl. No.: 14/221,944

(22) Filed: Mar. 21, 2014

(51) Int. Cl. G06Q 40/02

(52) U.S. Cl. CPC G06Q 40/025

(57) ABSTRACT

Presented are a system, method, and apparatus for loan risk assessment by assignment of a specific loan account to a loan cluster of a plurality of loan clusters. A computing device receives plurality of loan account histories describing a plurality of loan accounts during a training phase. An appropriate supervised classification method is applied to the loan account histories to obtain a mathematical description of loan cluster set. Next, the computing device receives a test loan account payment history describing a test loan account to be analyzed. The test loan account is assigned to at least one cluster of the previously trained cluster set. One or a plurality of causes is then determined for assigning the test loan account to the cluster set; and a predicted risk value for the test loan account is determined based on the cluster the test loan account is assigned to.

This application is related to co-filed U.S. patent application Ser. No. 14/221,723 and the co-filed U.S. patent application Ser. No. 14/222,099. These patent applications are incorporated in their entirety here.

### TECHNICAL FIELD

The present invention is related to the field of loan risk assessment. The invention is directed towards a system, method, and apparatus for loan risk assessment using cluster-based classification to easily determine and visualize risk associated with a particular loan account in order to provide a user the ability to trigger subsequent action on the account. In order to perform this task, in an embodiment of the invention (during a training phase) an analysis is performed by a computing device of a background of a plurality of loan account histories describing a plurality of loan accounts which are transmitted from a database. The plurality of loan account histories are utilized to obtain mathematical descriptions of a loan cluster set used for assessment and visualization of loan risk, via assignment of the particular loan account to a loan cluster after the training phase has ended. After assignment of the test loan account to at least one loan cluster has completed, causes for assigning the test loan account to the at least one loan cluster of the previously trained loan cluster set are determined, and a predicted risk value for the test loan account is next determined by the computing device based on the at least one loan cluster of the previously trained loan cluster set to which the test loan account is assigned. In an embodiment of the invention a visual representation is then displayed to the user of the system, method, and apparatus of the at least one loan cluster including the test loan account, associated risk, and other statistics.

### BACKGROUND

The personal lending industry, including the lending of student loans, auto loans, commercial loans, and mortgages, as well as other types of personal loans is valued at trillions of dollars in the United States in the twenty-first century. The total value of mortgages outstanding alone in the United States is $10 trillion dollars. The total value of all student loans outstanding in the United States in 2013 is currently between $902 billion and $1 trillion. The sheer volume of this debt leads to a large amount of competition among lenders, trying to extend the greatest number of loans which have a reasonable chance of being repaid with interest. The tendency to over-purchase existing personal loan accounts from other lenders as well as to over-lend leads to situations such as presented in the 2009 Financial Crisis in which defaults of large amounts of mortgages and mortgage-backed securities consisting of individual homeowner's mortgages led to the failure of almost the entire banking industry, and leading to the need for government bailouts to prevent another Great Depression.

Personal loan accounts consist of accounts such as auto loans, home mortgages, personal lines of credit, credit cards, student loans, and similar type of lending arrangements made to individuals. Whether a lender or loan servicer obtains management of personal loan accounts through directly lending, or via assignment of an existing personal loan account the need to obtain information on loan risks remains. In any event, once management of a personal loan account has been obtained, it is necessary to continuously monitor the potential for default for the personal loan account itself. Collection services, as well, require information on the status of loans, and whether collection should be pursued or not. Monitoring of loan accounts is required to determine whether the personal loan remains an asset valuable enough to remain “on the books,” whether to file a lawsuit against the personal loan holder to collect on the debt, whether to sell the personal loan to another owner or loan servicer, or another similar extreme recourse.

Accordingly, a need exists for a system, method, and apparatus for loan risk assessment which facilitates assessment of future risk and other statistics for personal loans.

### SUMMARY

The present invention proposes the application of clustering models (as “loan clusters”) to accounts of financial data, particularly student loan accounts but the system, method, and apparatus is also directly applicable to consumer loans, commercial loans, auto loans, mortgages, or any other type of loan accounts. The assigned loan cluster is indicative of future risk, as well as allows a user to visualize loan behavior via the loan clusters within a graphic user interface or other computer display device.

More specifically, the present invention is directed to a system, method, and apparatus for analysis and visualization of loan risk by assignment of a test loan account to a loan cluster of multiple loan clusters. In an embodiment of the invention, execution begins with a training phase, in which certain steps are performed (which may be performed in various orders and even with or without specific steps). A computing device receives variables describing a plurality of loan account histories regarding a plurality of loan accounts transmitted from a database. A computing device then applies an appropriate supervised classification method to the plurality of loan account histories to obtain a mathematical description of the loan cluster set in the course of training the loan cluster set. The supervised classification method used is chosen out of a plurality of supervised classification methods based on at least one of one or more qualitative property of the plurality of loan account histories and one or more quantitative property of the plurality of loan account histories. The quantitative properties may include a statistical moment of the plurality of loan account histories and a heteroscedasticity score of the plurality of loan account histories (as described further below). The qualitative properties may include, for example, the type of the loan, the origination source, descriptive information about the loan, text content such as discussions or logs related to originating or servicing the loan, etc. The mathematical descriptions of the loan cluster set may be defined by a number of clusters, a cluster centroid, a cluster radius, a number of elements of a cluster, lengths of axes of a cluster along different dimensions, and/or a multi-dimensional probability density function describing statistical properties of members of a cluster set.

In another embodiment of the invention, the training phase comprises the following alternate steps, which again may be performed in various orders and with or without certain steps. A computing device receives a plurality of loan account histories transmitted from a database. (Alternately, the database may only transmit loan account histories to the database satisfying a certain criteria in order to reduce the number of loan account histories considered, particularly when large amounts of loan data are being considered which would even noticeably slow down a computing device processing such data.) The heteroscedasticity score of the received plurality of loan account histories is then computed, and a heteroscedasticity score threshold is received. The computing device determines, via a switching mechanism, whether the heteroscedasticity score of the received plurality of loan account histories is greater than the heteroscedasticity score threshold. As discussed further herein, whether the data in the received plurality of loan account histories is heteroscedastic or homoscedastic is utilized for a determination of which type of supervised classification method is utilized for a test loan account. In embodiments of the invention the heteroscedasticity score threshold is in the range of 1.1 to 2.0. In another embodiment of the invention the heteroscedasticity score threshold is definable by a user. If the heteroscedasticity score of the received plurality of loan account histories is greater than the received heteroscedasticity score threshold, a supervised classification method suited for heteroscedastic data is applied to the plurality of loan account histories to obtain a mathematical description of the loan cluster set when training the loan cluster set. The supervised classification method suited for heteroscedastic data may be LDA with a Chernoff criterion or LDA Based on Matusita's Measure. On the other hand, if the heteroscedasticity score of the received plurality of loan account histories is less than or equal to the received heteroscedasticity score threshold, a supervised classification method suited for homoscedastic data is applied to the plurality of loan account histories to obtain a mathematical description of the loan cluster set when training the loan cluster set. The supervised classification method suited for homoscedastic data may be a Linear Discriminant Analysis, a Quadratic Discriminant Analysis, a Naïve Bayes, or a Perceptron Neural Net.

After receipt of the plurality of loan account histories as in one of the embodiments above and before applying a supervised classification method, the plurality of loan account histories may be modified via application of a Dimensionality Reduction Model. The Dimensionality Reduction Model may be applied via application of an N-dimensional space into an M-dimensional space, where N≧M. The Dimensionality Reduction Model utilized may be one or more of Principal Component Analysis, Singular Value Decomposition, Tensor Decomposition, Kernel Principal Component Analysis, Locally Linear Embedding, and Subspace Learning.

In still a further embodiment of the invention, a testing phase is entered for online prediction of risk for assignment of a test loan account to a loan cluster of multiple loan clusters. In the testing phase, the computing device receives test loan account payment history describing a test loan account to be analyzed for prediction of risk as well as analyzed in other ways as further discussed herein. The test loan account is then assigned to at least one loan cluster in the previously trained loan cluster set. The computing device then determines one or a plurality of causes for assigning the test loan account to the at least one loan cluster of the previously trained loan cluster set; and the computing device then determines a predicted risk value for the test loan account based on the loan cluster of the previously trained loan cluster set to which the test loan account is assigned.

The computing device may further compare present and historical behavior of the test loan account by comparing the loan cluster the test loan account is assigned to and one or a plurality of loan clusters the test loan account was previously assigned to. More specifically, the computing device may determine whether a change in a risk of default has occurred for the test loan account by comparing the loan cluster the test loan account is presently assigned to with the one or plurality of loan clusters the test loan account was previously assigned to; a cause for the change in the risk of default for the test loan account may be determined by comparing characteristics of the loan cluster the test loan account is presently assigned to with the one or plurality of loan clusters the test loan account was previously assigned to; and the computing device may display to a user the determined cause of the change in the risk of default.

After assignment of the test loan account to at least one loan cluster, a visual representation of the at least one loan cluster may be displayed to the user including the test loan account. The computing device may also display a visual representation of all loan clusters in the loan cluster set. The visual representation may take place via a graphic-user interface. Alternately, a print-out may be created via a printing device (or via any other means of displaying data to a user). Each of said loan clusters may display a future level of risk assessment unique to that loan cluster. Each of said loan clusters may be assigned a different color from a color-coded scheme such that each color of the color-coded scheme indicates a relative level of risk of all loan accounts in the loan cluster. The color-coded scheme may include the colors red, yellow, and green, indicating respectively a high level of risk, a medium level of risk, and a low level of risk.

These and other aspects, objectives, features, and advantages of the disclosed technologies will become apparent from the following detailed description of illustrative embodiments thereof, which is to be read in connection with the accompanying drawings.

### BRIEF DESCRIPTION OF THE DRAWINGS

FIG. 1 is a flowchart indicating the process of execution of an embodiment of the invention.

FIG. 2 is a flowchart displaying a further process of execution in an embodiment of the invention.

FIG. 3 is a chart displaying a historical color trend of a loan account as displayed to a user in an embodiment of the invention.

FIG. 4 is a simple diagram displaying a visual representation of a loan account.

FIG. 5 is a pie chart displaying a relative percentage of risk of default in an embodiment of the invention and a table showing a list of high risk accounts.

FIG. 6 is a graph displaying the application of a supervised classification method in an embodiment of the invention.

### DETAILED DESCRIPTION

Describing now in further detail these exemplary embodiments with reference to the figures as described above, the system, method, and apparatus for Loan Risk Assessment Using Cluster-Based Classification for Diagnostics is described below. It should be noted that the drawings are not to scale.

“Homoscedasticity” and “heteroscedasticity” are typically defined within the context of a sequence or a vector of random variables in the field of statistics. A sequence is “homoscedastic” if, even though the variables or vectors are random, they possess approximately the same finite variance. A sequence is “heteroscedastic” if, on the other hand, the variables within a sequence of random variables or vectors possess largely dissimilar variances. Whether a sequence possesses a dissimilar variance or not is determined by comparison to a “heteroscedasticity score threshold.” In the field of statistics, homoscedasticity or heteroscedasticity is tested for using the White test, the Breusch-Pagan test, the Koenker-Basset test, Goldfeld-Quandt test, or any other means presently existing or after-arising. Within the context of this patent application, “homoscedasticity” or “heteroscedasticity” refers to the homoscedasticity or heteroscedasticity of provided sample data, i.e., sample data involving a plurality of loan account histories which are transmitted from a database.

A “loan account” (within the context of this and associated patent applications) and the associated “loan account history” describing the loan account is a record of debt for the lending of money (typically, for a specific purpose such as a payment for school tuition, refinancing a house, purchasing an automobile, etc.). A loan account contains one or more of the following: principal amount, interest rate, terms of repayment, date(s) of repayment, etc. As discussed within this patent application and associated patent applications a loan account and an associated loan account history will exist in a format accessible to a computing device for processing as a spreadsheet, .csv value, matrix (as defined by certain programming languages), an array, a database entry, a linked-list, a tree-structure, other types of computer files or variables (or any other presently existing or after-arising equivalent). Variables tracked include the origination date of the loan, the original amount of the loan, the remaining principle balance to be paid, the date of the monthly payment, the current interest rate, the terms of repayment, number of original monthly payments, number of remaining monthly payments, whether each monthly payment was timely (true/false), number days delinquent of every monthly payment (from 0-integer), credit score of loan account holder at various points in time, etc. In a further embodiment of the invention, variables further include loan status (LS) (current or not), delinquency days (DD), and forbearance months (FM).

A “cluster” or “loan cluster” within the context of this patent application and related patent applications refers to a grouping of individual loans which display statistically similar characteristics. The underlying assumption in the present disclosure is that accounts grouped together in the same cluster tend to display similar historical as well as future characteristics. Clusters are technically implemented as a linked-list, data structure, series of memory pointers, variables, etc. A user using the presently disclosed system, method, and apparatus would view a cluster on the display of a computing device as a cloud or bubble filled with relevant information (even though such cloud or bubble is actually just a representation of the cluster for use by the human user).

A “computing device,” as discussed in the context of this patent application and related patent applications, refers to one or multiple computer processors acting together, a logic device or devices, an embedded system or systems, or any other device or devices allowing for programming and decision making. Multiple computer systems may also be networked together in a local-area network or via the internet to perform the same function. In one embodiment, a computing device may be multiple processors or circuitry performing discrete tasks in communication with each other. The system, method, and apparatus described herein are implemented in various embodiments as, to execute on a “computing device[s],” or, as is commonly known in the art, such a device specially programmed in order to perform a task at hand A computing device is a necessary element to process the large amount of data in a realistic time-frame (i.e., thousands, tens of thousands, hundreds of thousands, or more of loan accounts and loan account histories). Furthermore, the present invention may take the form of a computer program product embodied in any tangible medium of expression having computer usable program code embodied in the medium. Computer program code for carrying out operations of the present invention may operate on any or all of the “server,” “computing device,” “computer device,” or “system” discussed herein. Computer program code for carrying out operations of the present invention may be written in any combination of any one or more programming languages, including an object oriented programming language such as Java, Smalltalk, C++, or the like, conventional procedural programming languages, such as Visual Basic, “C,” or similar programming languages, or any other. After arising programming languages are contemplated as well.

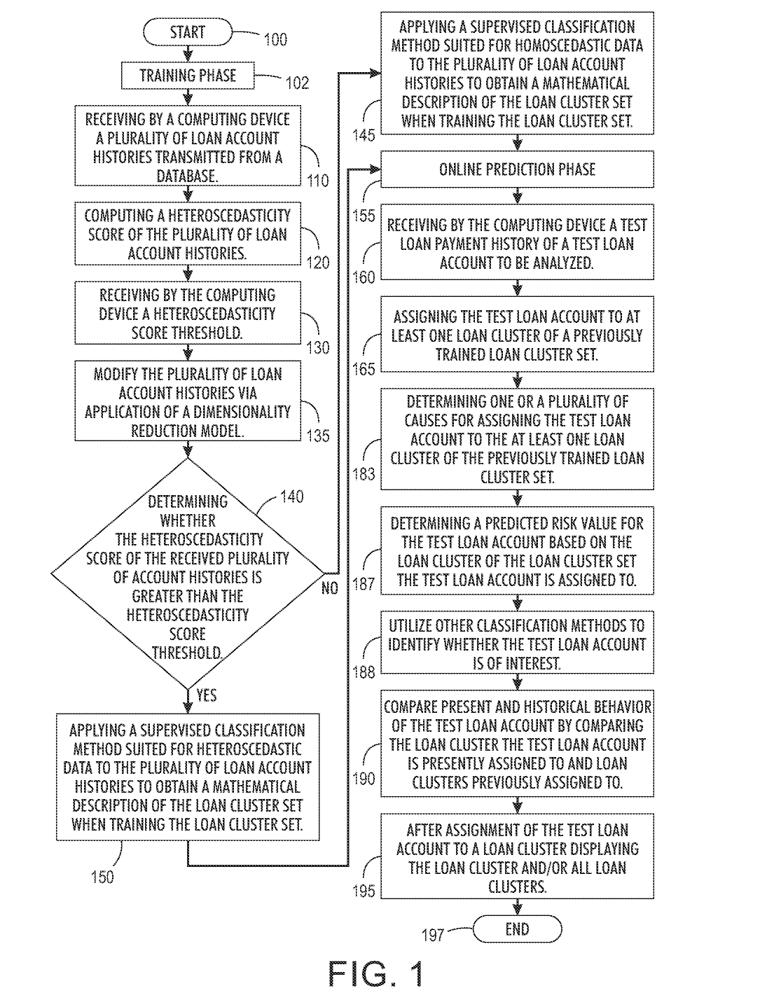

Referring to FIG. 1, displayed is a flowchart indicating the process of execution of an embodiment of the invention. In practice, the invention may comprise some, all, or none of these steps displayed in FIG. 1, or additional ones not displayed. The steps may even be performed concurrently or sequentially in embodiments of the invention. Execution begins at START 100. In an embodiment of the invention, a training phase begins at step 102. The computing device then receives a plurality of loan account histories describing a plurality of loan accounts that have been transmitted from a database 110. In an embodiment of the invention, the plurality of n loan account histories are defined as a set of historical information xₕεR^{n×m}, containing historical data for at least one month, MO>=1. The value of m=MO*V is determined by the number of variables, V, collected each month along with the number of months, MO, as historical data. Examples of variables V in various embodiments of the invention V are: loan's age (LA), forbearance months (FM), principal balance outstanding (PBO), delinquency days (DD), and number of on-time payments (NOTP). Other examples are possible depending on the type of loan being monitored. Assuming these variables are collected for the past 8 months (current month and seven months before), then |m|=┌MO┐·V=8·5=40. In an embodiment of the invention if only incomplete information is available regarding data points of the loan account, heuristic data is utilized to fill in the incomplete portions.

At step 120, the computing device computes a heteroscedasticity score of the received plurality of loan accounts. Computation of the homoscedasticity or the heteroscedasticity score of the plurality of loan accounts occurs in various embodiments via the White test, the Breusch-Pagan test, the Koenker-Basset test, Goldfeld-Quandt test, Cochran's C test, Hartley's test, or any other means. Other means of testing for heteroscedasticity or homoscedasticity are discussed, for example, in J. Schott, “A Test for the Equality of Covariance Matrices when the Dimension is Large Relative to Sample Sizes,” JOURNAL COMPUTATIONAL STATISTICS & DATA ANALYSIS, 2007, p. 6535-6542, Vol. 51, Issue 2, Elsevier, Bridgewater, N.J. All of these approaches are adopted here.

As execution proceeds, the computing device then receives a heteroscedasticity score threshold at step 130. In an embodiment of the invention, a heteroscedasticity score threshold in the range of 1.1 to 2.0 indicates data included in the received plurality of loan account histories is heteroscedastic. Typically, a heteroscedasticity score threshold of 1.7 is used. Other thresholds or ranges thereof can be used, depending on the application. The heteroscedasticity score threshold may also be defined by a user. “Heteroscedasticity” or “homoscedasticity” is defined as above within this application or may also be understood to mean a higher or lower relative level of variability between sub-populations of data in the loan account histories. In a further embodiment of the invention the heteroscedasticity threshold is definable by a user.

After step 130, optionally at step 135 the plurality of loan account histories are modified via application of a Dimensionality Reduction Model. In an embodiment of the invention, loan account history set xₕ is projected into low-dimensional space if the behavior of the plurality of loan account histories is too large for the computational resources available in the computing device. If this is the case, xₕ is standardized to obtain x_{std} (i.e., so that each column of x_{std} has a mean 0 and is scaled to have a standard deviation equal to 1). If V_{c} contains the c largest eigenvectors of the covariance of x_{std}, then x_{pca}=xₕ*V_{c}, projecting xₕ into the c-dimensional space. For example, the Dimensionality Reduction Model may project an N-dimensional space into an M-dimensional space, where N≧M. The Dimensionality Reduction Model may be as a means of non-limiting example a Principal Component Analysis, a Singular Value Decomposition, a Tensor Decomposition, a Kernel Principal Component Analysis, Locally Linear Embedding, and Subspace Learning.

After step 130 or step 135 execution proceeds to step 140 in an embodiment of the invention. At step 140 the computed heteroscedasticity score of the plurality of loan account histories is compared with the heteroscedasticity score threshold via a switching mechanism, to indicate the presence or absence of heteroscedasticity in the plurality of loan account histories. It is important to determine whether heteroscedastic or homoscedastic data is present because better results are obtained if techniques or classification methods appropriate to heteroscedastic or homoscedastic data are utilized.

If the computed heteroscedasticity score is lower than or equal to the received heteroscedasticity score threshold, execution proceeds to step 145 where a supervised classification method suited for homoscedastic data is applied to the plurality of loan account histories to obtain a mathematical description of the loan cluster set when training the loan cluster set. The supervised classification method suitable for homoscedastic data may be (by way of non-limiting example) a Linear Discriminant Analysis, a Quadratic Discriminant Analysis, a Naïve Bayes, a Naïve Bayes Kernel, and a Perceptron Neural Net.

On the other hand, if the computed heteroscedasticity score is greater than the received heteroscedasticity score threshold, execution proceeds from step 140 to step 150 where a supervised classification method suited for heteroscedastic data is applied to the plurality of loan account histories to obtain a mathematical description of the loan cluster set when training the loan cluster set. In an embodiment of the invention use input x_{pca} and output y_{cl} (as defined elsewhere herein). Algorithms that may be used in embodiments of the invention in connection with application of a supervised classification method suited for heteroscedastic data include, as a means of non-limiting example, LDA with the Chernoff criterion or LDA based on Matusita's measure. Use of these algorithms will output a variable w that will be used to map x_{pca} into another low-dimensional x_{lda}=x_{pca}*w.

In any embodiment of the invention a supervised classification method using x_{pca} and y_{cl}εR^{n×1} may be relied upon. x_{pca} contains historical data whereas y_{cl} contains the loan cluster numbers of accounts in the future. The variables x_{pca} and y_{cl} are utilized in various embodiments of supervised classification techniques to classify accounts x_{pca} for risk into the future (i.e., via review of cluster classification y_{cl}). Each loan cluster contains a description of the loan accounts assigned to that cluster. Some of the descriptions associated with a loan cluster include an observed risk or range of risk of the accounts in the loan cluster in the future (from the ground truth available at training), and observed cause or causes that influence the risk status of the accounts in the loan cluster in the future. More descriptive labels may be added to each loan cluster. These labels are available because clustering is performed with a training set of loan accounts, for which the complete history of risk and the associated causes for the risk are known. For example, in one embodiment, where five loan clusters are defined, a prediction horizon of six months is considered, and a risk range between 0 (low risk) and 100 (high risk) is observed, then possible descriptions of loan clusters are: loan cluster 1 (low risk) with risk equal to 0, loan cluster 2 (low-medium risk) with risk between limits (0, 30] and forbearance months less than 2, loan cluster 3 (medium risk) with risk between limits (30, 50] and forbearance months between (2 4], loan cluster 4 (med-high risk) with risk between limits (50, 80] and delinquency months (1 2], and loan cluster 5 (high risk) with risk between limits (80, 100] with delinquency months greater than 2. Therefore, each loan cluster indirectly provides a risk status via a risk descriptor (low, medium, high risk) or a risk value/range, as well as a potential cause of the future risk via the forbearance period length or number of delinquency months of the training accounts that belong to that cluster.

At either step 145 or step 150 mathematical descriptions of loan clusters are described by different data points such as one or more of: (1) a cluster centroid; (2) a cluster radius; (3) the number of elements of a cluster; (4) the lengths of axes of a cluster along different dimensions; and (5) a multi-dimensional probability density function describing the statistical properties of members of a cluster set.

In an alternate embodiment of the invention steps 120, 130, 140, 145, and 150 are not performed as described above. In such an embodiment at step 110 a plurality of loan account histories are transmitted from a database. The heteroscedasticity score of these loan account histories is not calculated at steps 120-130. The plurality of loan accounts may be modified via a dimensionality reduction model at step 135. In this embodiment, instead of performing steps 140, 145, and 150, where a supervised classification method is applied based upon whether or not heteroscedastic or homoscedastic data is present, in this embodiment a more general supervised classification method is applied to obtain a mathematical description of the loan cluster set when training the loan cluster set. In various embodiments of the invention, the supervised classification method used is chosen out of a plurality of supervised classification methods based upon any number of qualitative and/or quantitative properties of the plurality of loan account histories. The quantitative properties considered may include a statistical moment of the plurality of loan account histories and a heteroscedasticity score of the plurality of loan account histories. The qualitative properties may include, for example, the type of the loan, the origination source, descriptive information about the loan, text content such as discussions or logs related to originating or servicing the loan, etc.

At step 155 an online prediction phase is entered. At step 160 the computing device receives the payment history of a test loan account for analysis and placement among the plurality of loan clusters. The test loan account is received in order to analyze risk associated with the test loan account and performance of various loan risk analyses. At step 165 the test loan account is assigned to at least one loan cluster of the previously trained loan cluster set. In various embodiments of the invention the previously trained loan cluster set is trained as described above or a default loan cluster set is utilized.

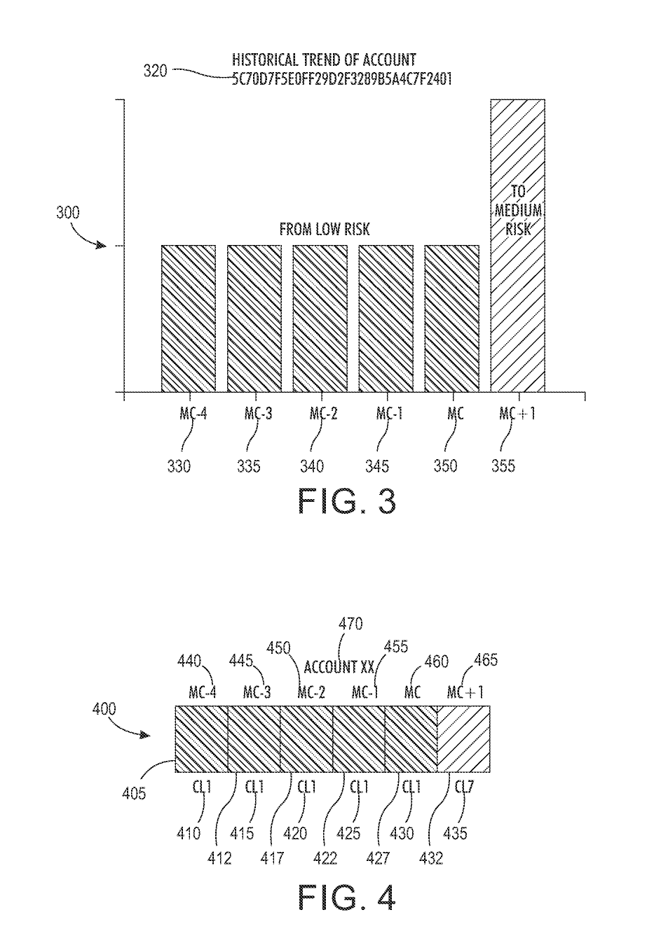

At step 183 one or a plurality of causes for assigning the test loan account to the at least one loan cluster of the previously trained loan cluster set are determined. A computing device performs this function via, for example, a review of the payment history of the specific loan account over previous months, a review of variables such as changes in credit score over previous months, review of the number of delinquency days over previous months, remaining monthly payments, forbearance requests over previous months, etc. Trends are calculated based on changes over time. After step 183, execution then terminates at step 197 in an embodiment of the invention. Again optionally, after or instead of step 183, the risk level of a loan account from present to months in the future is calculated and displayed. This may appear as FIG. 3 in an embodiment of the invention. At step 187 a predicted risk value for the test loan account is determined, based upon which loan cluster of the loan cluster set the test loan account is assigned to.

In another embodiment of the invention, optionally after step 187, at step 188 the risk classification system, method, and apparatus proposed herein may be utilized in combination with other classification methods, including those that are potentially slower to identify whether the test loan account is “of interest.” A test loan account is “of interest,” for example, if it is of high risk value, is in default, etc. Step 187 allows the risk classification method, system, and apparatus proposed herein to be utilized as a pre-screening step and to be combined with other slower classification methods at step 188 to identify accounts of interest, particularly when large amounts of loan data are being analyzed (e.g., loan data for hundreds of thousands of borrowers). The presently disclosed risk classification system, method, and apparatus is significantly more computationally efficient than other classification methods including those based, for instance, on feature selection and regression. In this manner, a hierarchical system may be designed with a lower level producing the output obtained in step 187 in a computationally efficient manner, and a higher level comprising a slower risk prediction method further delimiting data. Both results may be processed by a voting scheme in order to improve the accuracy of the risk prediction process and aggregating the results obtained from both levels.

At step 190 the present and historical behavior of the test loan account is analyzed by comparing the loan cluster the test loan account is presently assigned to and loan clusters the loan account was previously assigned to. In an embodiment of the invention, at step 190 present and historical behavior of the test loan account is compared via performance of the following steps. First, a determination is made by the computing device whether a change in a risk of default has occurred for the test loan account by comparing the loan cluster the test loan account is presently assigned to with one or plurality of loan clusters the test loan account was previously assigned to. Second, a cause for the change in the risk of default for the test loan account is determined by comparing characteristics of the loan cluster the test loan account is presently assigned to with the one or plurality of loan clusters the test loan account was previously assigned to. Thirdly, the computing device displays to a user the determined cause for the change in the risk of default.

At step 195, after assignment of the test loan account to a loan cluster, the user or users are displayed a loan cluster and/or all loan clusters. Each loan cluster may display a future risk assessment unique to that loan cluster. Each of the loan clusters may be assigned a different color from a color-coded scheme such that each color of the color-coded scheme indicates a relative level of risk of all loan accounts in the loan cluster. The color-coded scheme may, for example, contain the colors red, yellow, and green indicating respectively a high level of risk, a medium level of risk, and a low level of risk. The user may also be displayed a visual representation of all loan clusters in the loan cluster set. In an embodiment of the invention, the visual representation of the indicated loan cluster and/or other loan clusters are displayed in a graphical user interface to a user or users or printed via a printing device. Execution terminates at step 197.

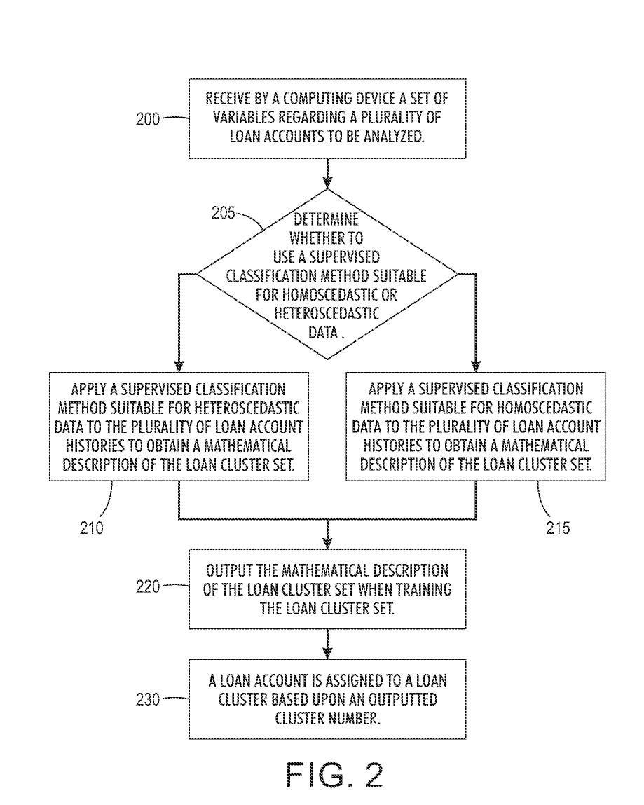

Referring to FIG. 2, displayed is a flowchart of an embodiment of the invention, displaying the process of applying a supervised classification method to a plurality of loan account histories to obtain a mathematical description of the loan cluster set when training a loan cluster set. At step 200, a computing device receives a set of variables indicating payment histories of a plurality of loan accounts to be analyzed. In an embodiment of the invention, the variables indicating the payment history of the plurality of loan accounts are described by xₕεR^{n×m}, from current month (MC) up to i months back (MC−i), where iεZ.

As one of skill in the art would know, in an embodiment of the invention the payment history of the plurality of loan accounts is implemented as a computer file (such as comma-separated value file, a text file, an excel file, etc.) or a data structure (such as a linked-list, a matrix or array, a tree-structure, etc.), or any other presently existing or after-arising equivalent. Variables describing the plurality of loan account histories include but are not limited to loan status (LS), delinquency days (DD), and forbearance months (FM). Execution continues to 205 where a determination is made which supervised classification method to use. By means of a non-limiting example, LDA may be utilized if the plurality of loan account histories comprise homoscedastic data, and LDA using Chernoff criterion may be utilized regardless of whether the plurality of loan account histories comprise homoscedastic or heteroscedastic data.

If the determination is made that a supervised classification method appropriate for heteroscedastic data should be used, at step 210 such a classification method is applied to the plurality of loan account histories to obtain a mathematical description of the loan cluster set when training the loan cluster set. On the other hand, if at step 205 a determination is made that a supervised classification method suitable for homoscedastic data is appropriate, at step 215 such a supervised classification method appropriate for homoscedastic data is applied to the set of variables from the current month to obtain a mathematical description of the loan cluster set when training the loan cluster set.

At step 215, the supervised classification method taking into account homoscedasticity may take the form (as a means of non-limiting example) of a linear discriminant analysis (LDA) with a pre-processing of the data in an embodiment of the invention. The steps for this method may be summarized as follows:
1. Principal Component Analysis (PCA) is applied to the training data xₕ to avoid singular covariance matrices. If V_{c} contains the eigenvectors with c components of the covariance matrix of x_{std} (xₕ is standardized to produce x_{std}), then x_{pca}=xₕ*Vc is the projection of the training data. The application of PCA also helps to perform a dimensionality reduction, which results in computational savings for the process of loan account classification.
2. Apply LDA with input x_{pca} and output y_{cl}.

At step 210, the supervised classification method taking into account heteroscedasticity may take the form of a Linear Discriminant Analysis (LDA) using the Chernoff criterion. LDA is a dimensionality reduction technique that preserves the discriminatory information present in labeled data as much as possible. It does so by finding the linear transformation that maximizes between-class variability while minimizing within-class variability of the data in the transformed domain. This approach takes into account differences in within-class covariance matrices and the discriminatory information therein. Another approach that may be used for homoscedastic data is the multi-class extension of LDA based on Matusita's separability measures (discussed in M. S. Mahanta, et al. “A Heteroscedastic Extension of LDA Based on Multi-Class Matusita Affinity,” INTERNATIONAL CONF. ON ACOUSTIC, SPEECH, AND SIGNAL PROCESSING, 2012, p. 1921-1924, IEEE (“M. S. MAHANTA”)), the entirety of which is incorporated here by reference. Next, shown is the following steps for the classification method discussed in M. S. MAHANTA or M. Loog, et al., “Linear Dimensionality Reduction via a Heteroscedastic Extension of LDA: the Chernoff Criteria,” IEEE TRANSACTIONS ON PATTERN ANALYSIS AND MACHINE INTELLIGENCE, 2004, p. 732-739, Vol. 26, Issue 6, IEEE Computer Society (“IEEE TRANSACTIONS”), the entirety of which is also incorporated here by reference.
1. Principal Component Analysis (PCA) is applied to the training data xₕ to avoid singular covariance matrices as discussed (as discussed in IEEE TRANSACTIONS). If V_{C} contains the eigenvectors with c components of the covariance matrix of x_{std} (xₕ is standardized to produce x_{std}), then x_{pcd}=xₕ*Vc is the projection of the training data. PCA is a dimensionality reduction technique generating a linear transformation that projects the data onto a new coordinate system with an axis defined by the principal components, whereby the first principal component accounts for the largest amount of variation possible, and each additional component captures the highest amount of variation possible along a direction orthogonal to every preceding component.
2. Apply LDA with the Chernoff criterion using x_{pca} as inputs and y_{cl} as outputs.
   We compute the matrix (as discussed in IEEE TRANSACTIONS):

$$CC = {\sum }_{i = 1}^{K - 1} {\sum }_{j = i + 1}^{E} {p}_{i} {p}_{j} {S}_{w}^{- 1} {S}_{w}^{\frac{1}{2}} [ {( {S}_{w}^{- \frac{1}{2}} {S}_{ij} {S}_{w}^{- \frac{1}{2}} )}^{- \frac{1}{2}} {S}_{w}^{- \frac{1}{2}} ( {m}_{i} - {m}_{j} ) {( {m}_{i} - {m}_{j} )}^{1} {{S}_{w}^{- \frac{1}{2}} ( {S}_{w}^{- \frac{1}{2}} {S}_{ij} {S}_{w}^{- \frac{1}{2}} )}^{- \frac{1}{2}} + \frac{1}{{m}_{i} {m}_{j}} ( log ( {S}_{w}^{- \frac{1}{2}} {S}_{i} {S}_{w}^{- \frac{1}{2}} ) - {π}_{i} log ( {S}_{w}^{- \frac{1}{2}} {S}_{i} {S}_{w}^{- \frac{1}{2}} ) - {π}_{j} log ( {S}_{w}^{- \frac{1}{2}} {S}_{j} {S}_{w}^{- \frac{1}{2}} ) ) ] {S}_{w}^{\frac{1}{2}} \qquad ( Eq . 1 )$$

where K denotes the number of classes, pᵢ is the prior of class i, S_{w} is the average within-class matrix, sᵢⱼ=πᵢSᵢ+πⱼSⱼ, Sᵢ denotes the within-class covariance matrix of class i, mᵢ is the mean vector of class i, and πᵢ is computed by:

$$\frac{{p}_{i}}{{p}_{i} + {p}_{j}}$$

Once the matrix CC is computed, proceed to form the matrix w with the eigenvectors with the d largest eigenvalues of CC. If the matrix Sᵢ is still singular after step 1) (above), regularization may be used to make it non-singular. If α is defined as a small scalar, then Sᵢ can be recomputed as

Sᵢ=αSi+(1−α)S_{w}
3. The new input space is computed by linearly converting the data using the matrix w, i.e., x_{cc}=x_{pca}*w, where w contains the eigenvectors of Eq. 1
4. Finally, a discriminant analysis method (linear or nonlinear) is applied to the input x_{cc} and output y_{cl} to obtain the cluster classifier.

In either event, after step 210 or step 215, at step 220, output the mathematical description of the loan cluster when training the loan cluster set. At step 230, a loan account is assigned to a loan cluster based upon an outputted cluster number.

Referring to FIG. 3, displayed is a chart displaying a historical color trend of a loan account 300 as displayed to a user in an embodiment of the invention. The account number is displayed 320. The relative risk at “MC−4” (or the current month minus 4 months, or four months in the past) is displayed 330, likewise for “MC−3” 335, “MC−2” 340, “MC−1” 345, and “MC” (or the current month) 350. Also displayed is the future risk assessment for the loan at “MC+1” (the current month plus 1 month, or one month in the future) 355.

Referring to FIG. 4, displayed is a simple diagram in an embodiment of the invention displaying a visual representation of a loan account numbered XX 400 (as a manner of example) categorized in loan cluster CL1 for four past months and the current month (see 410, 415, 420, 425, and 430) and then classified in loan cluster CL7 for an upcoming month five months in the future 435. The visual representation allows for a user of the presently disclosed system, method, and apparatus to easily and quickly check the status of a loan account in the past, present, and in the future. After a user chooses to view data regarding loan account XX, he or she is presented with the visual representation of loan account XX 400. The name/account number of loan account XX is presented 470. A color-coded scheme is used to indicate relative risk of the loan account at different time frames. At 405 the relative risk of the loan account at “MC−4” 440 (or the current month minus 4 months) is displayed via the color of a square in the visual representation 400, indicating a “low” level of risk existed at the time. At MC−4 440 this loan was classified in cluster CL1 410. The visual representation 400 displays at 412 the relative risk of the loan account at “MC−3” 445 (or the current month minus 3 months), which risk is displayed via the color of the square 412. At MC−3 445 the loan is still assigned to cluster CL1 415. Displayed at 417 is the relative risk of the loan account at “MC−2” (or the current month minus 2 months) 450. At MC−2 450 the loan is still classified in cluster CL1 420. Again, at MC−1 455 the loan is classified in cluster CL1 425. The loan at MC−1 455 has the same coloration and therefore risk as previous months. The loan at MC 460 is again classified in CL1 430 for the same level of risk. The box 427 for this loan has the same risk level, and color as previously. A change, however, takes place in at “MC+5” (or the current month plus 5 months) 465. A color change of box 432 indicates the level of risk has risen to “medium” from “low” at five months in the future 465. The loan has also been reassigned to cluster “CL7” 435. This change indicates to the user of an upcoming lowered level of risk associated with loan account XX.

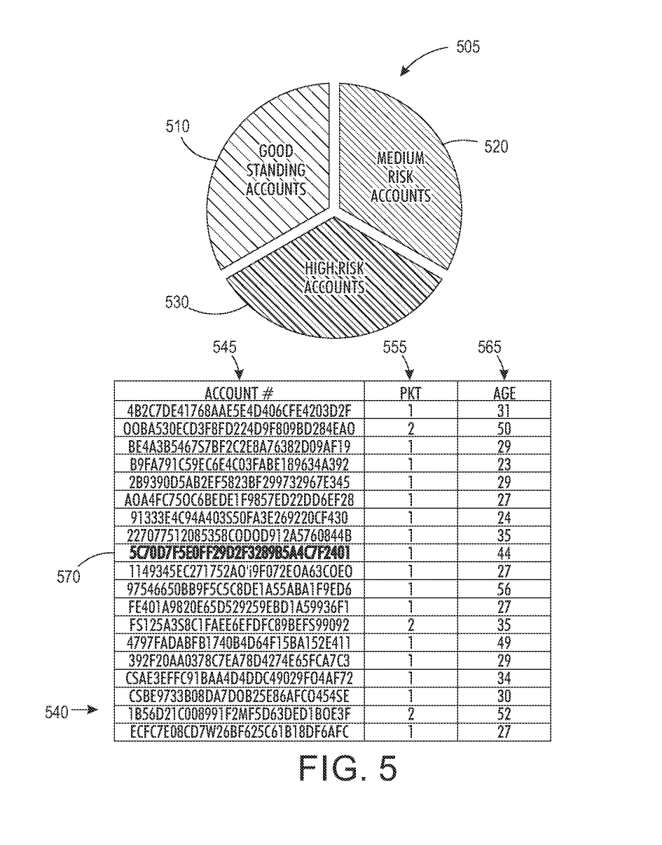

Referring to FIG. 5, displayed is a pie chart 505 a user may access in an embodiment of the invention displaying a relative percentage of a risk of default of all loan accounts in an embodiment of the invention and a table 540 displaying a listing of all high-risk accounts. A user selects a month for which all loan accounts are to be displayed “MC+i” (where “MC” is a variable indicating the current month, and where i is a zero, positive, or negative integer value indicating the present month, a future month, or a past month, respectively). After a user has selected a month, displayed is pie chart 505. Pie chart 505 displays the relative risk of all loan accounts by relative size of sector 510 indicating a numeric proportion of accounts in good standing, sector 520 indicating a numeric proportion of accounts at medium risk of defaulting, and sector 530 indicating a numeric proportion of accounts at high risk of defaulting. The area (and arc length) of sectors 510, 520, and 530 indicate to the user the relative number of accounts at a certain level of risk of defaulting, providing for an easy visual means for accessing data on risk associated with many loan accounts. If a user clicks on sectors 510, 520, or 530, presented is a list of accounts included at the relative risk level. If the user clicks on sector 530 indicating loans at high risk of defaulting, displayed to the user is a table 540 including a column of high risk accounts 540 at month MC+i (as discussed above). Table 540 displays a list of all accounts currently at high risk of default. Displayed are the account numbers of the high risk accounts in column 545, the current loan cluster the accounts are assigned to 555, and the ages of the account holders 565. A user clicking on a loan account (such as loan account at item 570) in an embodiment of the invention will present the user with further data on loan account, as further discussed in connection with FIG. 4 (above).

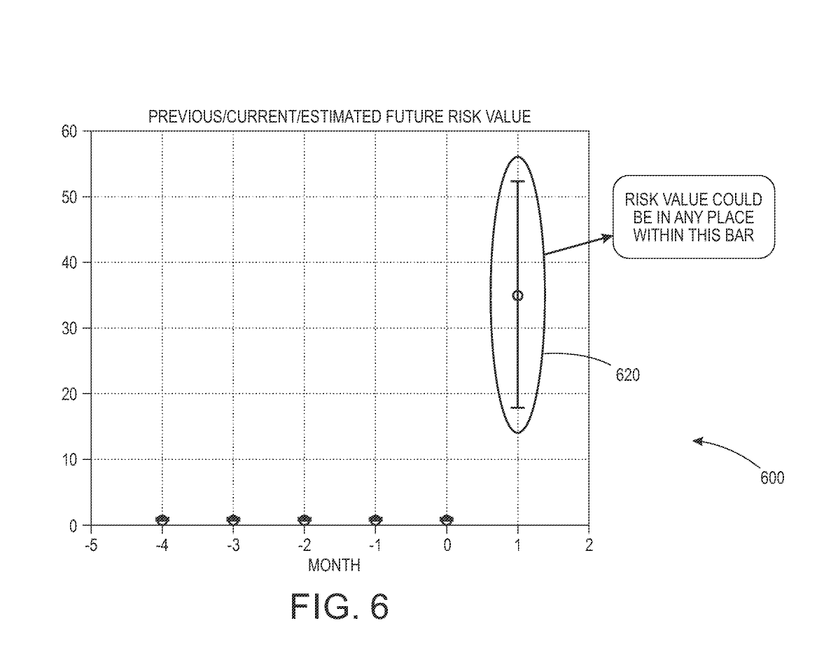

Referring to FIG. 6, displayed is a graph 600 displaying the output of an application of a supervised classification method suitable for heteroscedastic data in an embodiment of the invention where an expected risk value (item 620) and its standard deviation (bars) are shown for the case when the user demands that information by clicking, for example, on item 570 of FIG. 5. In generating this data, the following process may be implemented:

Split the original data into xₜᵣₐᵢₙεR^{137,987×332},yₜᵣₐᵢₙεR^{137,987×332} and xₜₑₛₜεR^{59,138×332}, yₜₑₛₜεR^{59,138×1}.

For example, in order to generate such data, the following steps may be followed:

1) Apply PCA to the training data and select c=150 to obtain x_{pca}_{_{—}}ₜᵣₐᵢₙεR^{137,987×150} and x_{pca}_{_{—}}ₜₑₛₜεR^{59,138×150}. Since Sᵢ matrices are singular, apply regularization using α=1e⁻³.
2) Compute CC and x_{pca}_{_{—}}ₜᵣₐᵢₙ, yₜᵣₐᵢₙ. Proceed to select the d=10 largest eigenvalues of CC and derive the matrix wεR^{150×10} with d eigenvectors from the matrix CC. Compute the new input space using the matrix w, i.e. x_{cc}_{_{—}}ₜᵣₐᵢₙ=x_{pca}_{_{—}}ₜᵣₐᵢₙ*wεR^{137,987×10}. Compute the new input space using the matrix w, i.e. x_{cc}_{_{—}}ₜᵣₐᵢₙ=x_{pca}_{_{—}}ₜᵣₐᵢₙ*wεR^{137,987×10}. Also computed is x_{cc}_{_{—}}ₜₑₛₜ=x_{pca}_{_{—}}ₜᵣₐᵢₙ*wεR^{59,138×10}.
3) Use a quadratic discriminant with the input x_{cc}_{_{—}}ₜᵣₐᵢₙ and yₜᵣₐᵢₙ to derive a classification method.
4) Obtain a performing metric using the classification method for both training and testing data. The metric is the net deviation b.

The preceding description has been presented only to illustrate and describe the invention. It is not intended to be exhaustive or to limit the invention to any precise form disclosed. Many modifications and variations are possible in light of the above teachings.

The preferred embodiments were chosen and described in order to best explain the principles of the invention and its practical application. The preceding description is intended to enable others skilled in the art to best utilize the invention in its various embodiments and with various modifications as are suited to the particular use contemplated. It is intended that the scope of the invention be defined by the following claims.

What is claimed is:

1. A method for online prediction of risk by assignment of a loan account to a loan cluster of multiple loan clusters comprising:
Receiving by a computing device a test loan account payment history describing a test loan account to be analyzed;
Assigning the test loan account to at least one loan cluster in a previously trained loan cluster set;
Determining by the computing device one or a plurality of causes for assigning the test loan account to the at least one loan cluster of the previously trained loan cluster set; and
Determining by the computing device a predicted risk value for the test loan account based on the at least one loan cluster of the previously trained loan cluster set to which the test loan account is assigned.

2. The method of claim 1 wherein the previously trained loan cluster set is trained during a training phase, the training phase comprising:
Receiving by the computing device a plurality of loan account histories describing a plurality of loan accounts transmitted from a database; and
Applying by the computing device a supervised classification method to the plurality of loan account histories to obtain a mathematical description of the loan cluster set when training the loan cluster set.

3. The method of claim 2 wherein said mathematical descriptions of loan clusters are described by selectively one or more of the following: a number of clusters, a cluster centroid, a cluster radius, a number of elements of a cluster, lengths of axes of a cluster along different dimensions, and a multi-dimensional probability density function describing statistical properties of members of a cluster set.

4. The method of claim 2 wherein the supervised classification method used is chosen out of a plurality of supervised classification methods based on at least one of the following:
one or more qualitative property of the plurality of loan account histories, and
one or more quantitative property of the plurality of loan account histories.

5. The method of claim 3 wherein said quantitative properties include selectively one of a statistical moment of the plurality of loan account histories and a heteroscedasticity score of the plurality of loan account histories.

6. The method of claim 1 wherein the previously trained loan cluster set is trained during a training phase, the training phase comprising:
Receiving by the computing device a plurality of loan account histories describing a plurality of loan accounts transmitted from a database;
Computing a heteroscedasticity score of said received plurality of loan account histories;
Receiving by the computing device a heteroscedasticity score threshold;
Determining by the computing device via a switching mechanism whether the heteroscedasticity score of said received plurality of loan account histories is greater than the received heteroscedasticity score threshold;
If said heteroscedasticity score of the received plurality of loan account histories is greater than the received heteroscedasticity score threshold, then performing the following:
Applying a supervised classification method suited for heteroscedastic data to the plurality of loan account histories to obtain a mathematical description of the loan cluster set when training the loan cluster set;
Else if said heteroscedasticity score of the received plurality of loan account histories is less than or equal to the received heteroscedasticity score threshold, then performing the following:
Applying a supervised classification method suited for homoscedastic data to the plurality of loan account histories to obtain a mathematical description of the loan cluster set when training the loan cluster set.

7. The method of claim 2 further comprising after receipt of the plurality of loan account histories and before applying the supervised classification method, modifying the plurality of loan account histories via application of a Dimensionality Reduction Model.

8. The method of claim 7 wherein the Dimensionality Reduction Model is applied via computing a projection of an N-dimensional space into an M-dimensional space, where N≧M.

9. The method of claim 8 wherein the Dimensionality Reduction Model is selectively one of: Principal Component Analysis, Singular Value Decomposition, Tensor Decomposition, Kernel Principal Component Analysis, Locally Linear Embedding, and Subspace Learning.

10. The method of claim 1 wherein said computing device further compares present and historical behavior of the test loan account by comparing the loan cluster the test loan account is assigned to and one or a plurality of loan clusters to which the test loan account was previously assigned.

11. The method of claim 10 further comprising:
Determining by the computing device whether a change in a risk of default has occurred for the test loan account by comparing the loan cluster to which the test loan account is presently assigned with the one or plurality of loan clusters to which the test loan account was previously assigned;
Determining a cause for the change in the risk of default for the test loan account by comparing characteristics of the loan cluster to which the test loan account is presently assigned with the one or plurality of loan clusters to which the test loan account was previously assigned; and
Displaying by the computing device to a user the determined cause for the change in the risk of default.

12. The method of claim 1 further comprising after assignment of the test loan account to at least one loan cluster, displaying to a user a visual representation of the at least one loan cluster including the test loan account.

13. The method of claim 6 wherein said heteroscedasticity score threshold is in a range of 1.1 to 2.0.

14. The method of claim 1 further comprising displaying to a user a visual representation of all loan clusters in the loan cluster set.

15. The method of claim 14 wherein each of said loan clusters is assigned a different color from a color-coded scheme such that each color of the color-coded scheme indicates a relative level of risk of all loan accounts in the loan cluster.

16. The method of claim 15 wherein the color-coded scheme includes the colors red, yellow, and green indicating respectively a high level of risk, a medium level of risk, and a low level of risk.

17. The method of claim 14 wherein each of said loan clusters displays a future risk assessment unique to that loan cluster.

18. The method of claim 6 wherein said heteroscedasticity score threshold is definable by a user.

19. The method of claim 2 wherein said database only transmits loan account histories to said computing device satisfying a certain criteria.

20. The method of claim 6 wherein the supervised classification method suited for heteroscedastic data is selectively one of LDA with a Chernoff criterion and LDA Based on Matusita's Measure.

21. The method of claim 6 wherein the supervised classification method suited for homoscedastic data is selectively one of a Linear Discriminant Analysis, a Quadratic Discriminant Analysis, a Naïve Bayes, a Nave Bayes Kernel, and a Perceptron Neural Net
